(19) United States
(12) Patent Application Publication
(10) Pub. No.: US 2026/0158567 A1
(43) Pub. Date: Jun. 11, 2026

(54) HANDHELD WORK APPARATUS AND METHOD FOR OPERATING SAME

(71) Applicant: Andreas Stihl AG & Co. KG, Waiblingen (DE)

(72) Inventors: Tim Vogt, Schwäbisch Gmünd (DE); Alexander Berger, Weinstadt (DE); Johannes Alber, Stuttgart (DE); Christopher Tost, Auenwald (DE)

(21) Appl. No.: 19/412,264

(22) Filed: Dec. 8, 2025

(30) Foreign Application Priority Data
Dec. 9, 2024 (DE) 10 2024 136 685.0

(51) Int. Cl. B23D 59/00; B23D 45/16; B23D 47/12

(52) U.S. Cl. CPC B23D 59/001; B23D 45/16; B23D 47/12

(57) ABSTRACT

A work apparatus includes a cutting disk driven by a drive motor, a protective hood covering the disk around a portion of its circumference and which is adjustable by the user in an opening direction and a closing direction, a device for detecting the hood position, and a control unit. The control unit operates the work apparatus in a first operating mode and in a second operating mode and, depending on the hood position detected, to switch from the first into the second operating mode upon adjustment of the hood in the opening direction and to switch from the second into the first operating mode upon adjustment of the hood in the closing direction. The switch from the first into the second operating mode occurs with the hood in a first position. The switch from the second into the first operating mode occurs with the hood in a second position.

### CROSS-REFERENCE TO RELATED APPLICATIONS

This application claims priority of German patent application no. 10 2024 136 685.0, filed Dec. 9, 2024, the entire content of which is incorporated herein by reference.

### BACKGROUND

US 2019/0070746 discloses a cut-off saw, on the protective hood of which a detection device is provided. The detection device is formed by a pin which is guided on the cantilever arm and which slides over the protective hood when the protective hood is adjusted. The pin acts on an electric switch. The cut-off saw is actuated depending on whether the electric switch is open or closed.

### SUMMARY

It is an object of the disclosure to provide a work apparatus which exhibits good operating behavior. It is a further object of the disclosure to specify a method for operating a work apparatus, with which good operating behavior can be achieved.

The object is, for example, achieved via a work apparatus including: a drive motor; a cutting disk configured to be driven by the drive motor and defining a disk circumference; a protective hood which covers the cutting disk around a portion of the disk circumference and which is adjustable by a user in an opening direction and an opposite closing direction; a detection device for detecting a position of the protective hood; a control unit configured to operate the work apparatus in a first operating mode and in a second operating mode and, depending on the position of the protective hood detected by the detection device, to switch from the first operating mode into the second operating mode upon adjustment of the protective hood in the opening direction and to switch from the second operating mode into the first operating mode upon adjustment of the protective hood in the closing direction, wherein the switch from the first operating mode into the second operating mode occurs with the protective hood in a first position; and, wherein the switch from the second operating mode into the first operating mode occurs with the protective hood in a second position, wherein the second position of the protective hood is reached upon adjustment of the protective hood in the closing direction after the first position.

With regard to the method, the object is, for example, achieved via a method for operating a work apparatus having a drive motor, a cutting disk configured to be driven by the drive motor, a protective hood which covers the cutting disk around a portion of a circumference of the cutting disk and which is adjustable by the user in an opening direction and an opposite closing direction, the work apparatus further having a detection device for detecting a position of the protective hood and a control unit, wherein the control unit is configured to operate the work apparatus in a first operating mode and in a second operating mode and, depending on the position of the protective hood detected by the detection device, switches from the first operating mode into the second operating mode upon adjustment of the protective hood in the opening direction and switches from the second operating mode into the first operating mode upon adjustment of the protective hood in the closing direction. The method includes: switching. via the control unit, from the first operating mode into the second operating mode with the protective hood in a first position; and, switching, via the control unit, from the second operating mode into the first operating mode with the protective hood in a second position, wherein the second position of the protective hood is reached upon adjustment in the closing direction after the first position.

In known work apparatuses such as cut-off saws, for example, a switch takes place between a first operating mode and second operating mode when the protective hood is in a defined position. If the protective hood is placed in this defined position by the operator, the vibrations that arise during operating can result in frequent actuation of the switch and, as a result, switching back and forth between the operating modes. In order to avoid this, provision is now made to switch between the operating modes at different positions of the protective hood, specifically depending on whether the protective hood is being adjusted in the opening direction or in the closing direction. As a result, frequent switching between the operating modes, caused, for example, by vibrations, can be avoided in a simple manner. The switch from the first operating mode into the second operating mode takes place with the protective hood in a first position. The switch from the second operating mode into the first operating mode takes place with the protective hood in a second position. The second position of the protective hood is reached upon adjustment of the protective hood in the closing direction after the first position. The abovementioned positions of the protective hood can change over the lifetime of the work apparatus, for example on account of soiling or wear. To avoid rapid changing of the operating modes, all that needs to be ensured is that the first position and the second position are not identical. The first position of the protective hood and the second position of the protective hood correspond in particular to angular positions of the protective hood about a rotational axis about which the protective hood is pivotable.

The fact that the switch between the operating modes takes place with the protective hood in a first and a second position means that switching takes place between the operating modes when the first or the second position, respectively, of the protective hood is crossed during the adjustment of the protective hood.

The first position of the protective hood and the second position of the protective hood are, in particular, spaced apart from one another through at least 1°, in particular through at least 2° about the rotational axis of the cutting disk. This means that when the protective hood is being adjusted in the closing direction, it needs to be adjusted through at least 1° beyond the first position in order for the control unit to set the work apparatus back into the first operating mode. The spacing of the positions is, in particular, greater than relative movements that arise during operation between the elements on which the units of the detection device are arranged, for example on account of vibrations. The elements on which the units of the detection device are arranged may be, for example, the protective hood and, when the work apparatus is a cut-off saw, a cantilever arm of the cut-off saw.

The control unit is configured, in particular, to activate a rotational speed limiting device in the second operating mode. The rotational speed limiting device is, in particular, deactivated in the first operating mode. The deactivation of the rotational speed limiting device in the first operating mode is effected, in particular, by the control unit.

The rotational speed limiting device is, in particular, a device which limits the maximum rotational speed of the work apparatus. Below the maximum rotational speed, the work apparatus works in particular identically in the first operating mode and in the second operating mode.

In particular, the maximum rotational speed of the work apparatus in the second operating mode is 60% to 70% of the maximum rotational speed of the work apparatus in the first operating mode.

Alternatively or additionally, provision is made, in particular, for the control unit to be configured to activate a brake unit of the work apparatus in the second operating mode. In particular, the control unit is configured to deactivate the brake unit in the first operating mode. In particular when the drive motor is an electric motor, the brake unit may be in the form of a motor brake.

A simple structure of the work apparatus arises when the detection device has at least one magnet and at least one sensor, in particular a Hall sensor, for detecting the magnetic field strength of the at least one magnet. This results in a simple and robust structure. Alternatively, the detection device may also have another sensor. In particular, the sensor is a sensor that supplies an electric sensor signal.

In particular, the magnet is located in the region of the at least one sensor in the first operating mode. When the protective hood is in a position assigned to the second operating mode, the magnet is, in particular, not located in the region of the sensor and cannot be detected by the sensor.

The magnet is secured to the protective hood in particular by clamping, adhesive bonding or molding in place.

In particular, the magnet extends over an extension angle of at least 35° about the rotational axis of the cutting disk.

The switch from the first operating mode into the second takes place in particular when the measured value from the at least one sensor reaches a first threshold value. The switch from the second operating mode into the first operating mode takes place in particular when the measured value from the detection device reaches a second threshold value. The second threshold value of the measured value is, in this case, assigned to the second position of the protective hood, and the first threshold value is assigned to the first position of the protective hood.

The difference between the first threshold value and the second threshold value amounts, in particular, to at least 5%, in particular at least 10%, of the difference between the maximum measured value and the minimum measured value from the detection device, which arise during the adjustment of the protective hood between its end positions.

The work apparatus is, in particular, a cut-off saw. The cut-off saw has, in particular, a cantilever arm on which the cutting disk is rotatably mounted. A simple structure arises when the at least one sensor is arranged on the cantilever arm and the at least one magnet is arranged on the protective hood.

An advantageous structure is achieved in particular when the at least one magnet is oriented such that an imaginary plane that extends perpendicularly to the rotational axis of the cutting disk intersects the magnet through its north pole and south pole. The plane of the magnet, which extends between the north pole and south pole, is oriented, in particular, parallel to the rotational axis of the cutting disk.

The at least one sensor is, in particular, secured to a circuit board which is inclined at less than 45° to the rotational axis of the cutting disk. In particular, the circuit board extends parallel to the rotational axis of the cutting disk. It has been found that, even with the magnet and circuit board oriented in the abovementioned manner, sufficiently strong measurement signals can be generated in the sensor. The arrangement of the circuit board in an inclined manner, in particular parallel to the rotational axis of the cutting disk, results in a space-saving arrangement of the sensor. This allows a small, compact structure of the cantilever arm.

Upon movement of the protective hood in the opening direction, in particular the circumferential region of the cutting disk that is located at the top in the usual working posture of the work apparatus and is not covered by the protective hood increases in size. In particular, the work apparatus is a cut-off saw. The region of the cutting disk that is located at the top in the usual working posture corresponds in particular to a region arranged at the top when the cut-off saw is in a position set down on a level, horizontal set-down surface. The cut-off saw has, in particular, at least one handle which is provided for guiding the cut-off saw during operation. In particular, one handle is a rear handle. In particular, one handle is a bow handle.

The closing direction extends in particular in the direction of rotation of the cutting disk. The opening direction extends in particular in the opposite direction to the direction of rotation of the cutting disk.

The cutting disk is, in particular, mounted rotatably on a cantilever arm of the work apparatus in the form of a cut-off saw. The cantilever arm has a longitudinal center axis. The longitudinal center axis extends in the longitudinal direction of the cantilever arm and intersects the rotational axis of the cutting disk.

As seen in the direction of the rotational axis of the cutting disk, upon adjustment of the protective hood in the opening direction, in particular the portion of the circumference of the cutting disk that is not covered by the protective hood and is arranged on the same side of the longitudinal center axis as the at least one handle increases in size. Upon adjustment of the protective hood in the closing direction, in particular the portion of the circumference of the cutting disk that is not covered by the protective hood and is arranged on the same side of the longitudinal center axis, as seen in the direction of the rotational axis of the cutting disk, as the at least one handle decreases in size.

For a method for operating a work apparatus having a drive motor and having a cutting disk driven by the drive motor, having a protective hood which covers the cutting disk around a portion of its circumference and which is adjustable by the user in an opening direction and an opposite closing direction, having a detection device for detecting the position of the protective hood, and having a control unit, wherein the control unit operates the work apparatus in a first operating mode and in a second operating mode and, depending on the position of the protective hood detected by the detection device, switches from the first operating mode into the second operating mode upon adjustment in the opening direction and switches from the second operating mode into the first operating mode upon adjustment of the protective hood in the closing direction, wherein the control unit switches from the first operating mode into the second operating mode with the protective hood in a first position, provision is made for the control unit to switch from the second operating mode into the first operating mode with the protective hood in a second position, wherein the second position of the protective hood is reached upon adjustment of the protective hood in the closing direction after the first position.

In particular, the control unit determines, when the work apparatus is started up, whether the position of the protective hood is assigned to the first operating mode or to the second operating mode, and set the appropriate operating mode. Even when the protective hood is rotated with the work apparatus switched off, the work apparatus starts as a result in the operating mode that is assigned to this position of the protective hood. In this case, the control unit has in particular stored in its memory which of the first and second operating mode needs to be set when the protective hood is in a position between the first and the second position.

### BRIEF DESCRIPTION OF DRAWINGS

The invention will now be described with reference to the drawings wherein:

FIG. 1 shows a side view of an embodiment of a work apparatus with the protective hood in a first end position, in which the protective hood is closed;

FIG. 2 shows a part of the cantilever arm, of the cutting disk and of the protective hood of the work apparatus in FIG. 1 in a second end position of the protective hood, in which the protective hood is wide open;

FIG. 3 shows the work apparatus from FIG. 1 with the protective hood partially open;

FIG. 3A shows a sectional illustration of a detail of FIG. 3 in the region of a cantilever arm of the work apparatus, in which the approximate course of the cuts is indicated;

FIG. 4 shows a sectional illustration through a detail of the cantilever arm and the protective hood of the work apparatus from FIG. 3 along the line III-III in FIG. 3A;

FIG. 5 shows a side view of the work apparatus with the protective hood in the second end position;

FIG. 6 shows a sectional illustration through a detail of the cantilever arm from FIG. 5 in an illustration corresponding to FIG. 4;

FIG. 7 shows a perspective illustration of a detail of the base body of the cantilever arm in the region of the sensor module;

FIG. 8 shows a sectional illustration of a detail along the line VIII-VIII in FIG. 3A;

FIG. 9 shows a diagram that indicates the relationship between the measured value from the sensor and the opening angle of the protective head;

FIG. 10 shows an enlarged illustration of a detail of a region of the diagram in FIG. 9;

FIG. 11 shows a schematic illustration of the switching between the operating modes depending on the position and adjustment direction of the protective hood; and,

FIG. 12 shows a schematic illustration of the sequence of the method for operating the work apparatus.

### DETAILED DESCRIPTION

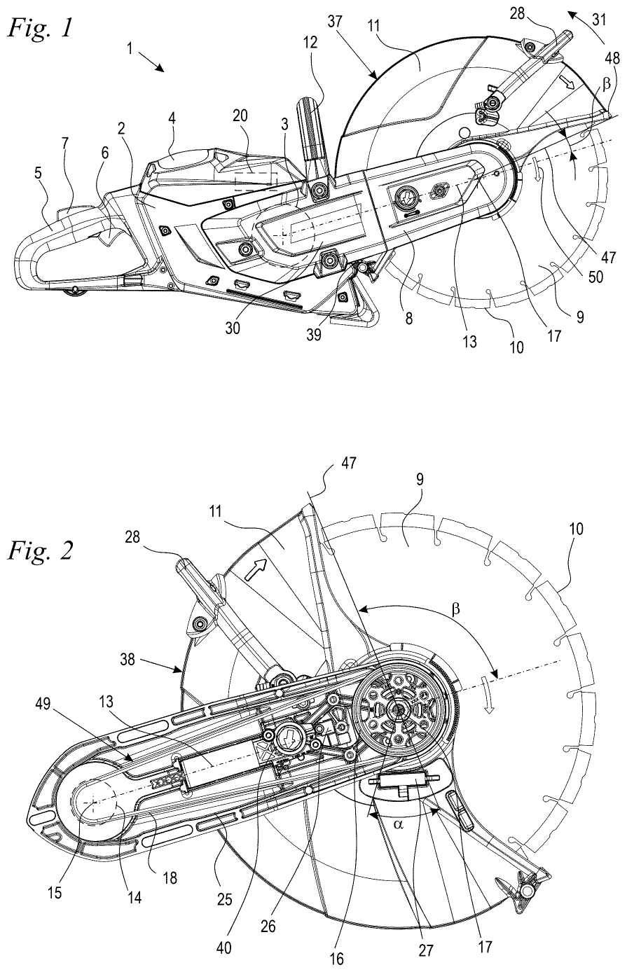

FIG. 1 shows a side view of a work apparatus 1. In the embodiment, the work apparatus 1 is a cut-off saw. The work apparatus 1 may also be some other work apparatus, for example an angle grinder. The work apparatus 1 includes a housing 2, in which a drive motor 3 is arranged. In the embodiment, the drive motor 3 is an electric drive motor. Provided for the power supply of the drive motor 3 is a battery 4, which is held in the housing 2. The drive motor 3 may also be an internal combustion-driven drive motor 3, in particular a mixture-lubricated internal combustion engine such as a two-stroke engine or a mixture-lubricated four-stroke engine.

To guide the work apparatus 1 during operating, two handles 5 and 12 are provided in the embodiment. The handle 5 is in the form of a rear handle. Arranged on the handle 5 are an operator-controlled lever 6 and an operator-controlled lever lock 7. The handle 12 is in the form of a bow handle. The handle 12 crosses over the housing 2 on the opposite side of the housing 2 from the rear handle 5, next to a protective hood 11.

Arranged on the housing 2 is a cantilever arm 8. A cutting disk 9 is rotatably mounted on the cantilever arm 8. The cutting disk 9 is driven in rotation by the drive motor 3. The cutting disk 9 is driven in a direction of rotation 50 during operation. The cutting disk 9 has a circumference 10. A part of the circumference 10 of the cutting disk 9 is covered by the protective hood 11. The protective hood 11 is mounted pivotably on the cantilever arm 8. The protective hood 11 has a grip 28, by way of which an operator can take hold of the protective hood 11 in order to adjust the protective hood 11. The protective hood 11 is pivotable about a rotational axis, which corresponds to a rotational axis 17 of the cutting disk 9 in the embodiment.

The grip 28 may be configured with an integrated water supply.

In FIG. 1, the protective hood 11 is illustrated in a first end position 37, which corresponds to a completely closed position of the protective hood 11. In the embodiment, the first end position 37 is defined by a stop 39 formed on the protective hood 11. The stop 39 cooperates with the cantilever arm 8. Other ways of setting the first end position 37 of the protective hood 11 may also be advantageous.

The cantilever arm 8 has a longitudinal center axis 13. The longitudinal center axis 13 extends in the longitudinal direction of the cantilever arm 8 and intersects the rotational axis 17 of the cutting disk 9.

The position of the protective hood 11 is specified as an opening angle β in the present case. The opening angle β is indicated between the longitudinal center axis 13 and a line 47 which is contiguous with an edge 48 of the protective hood 11 and correlates with the position of the protective hood 11. The line 47 divides the portion of the circumference 10 of the cutting disk 9 that is covered radially toward the outside by the protective hood 11 with respect to the rotational axis 17 from the portion of the circumference 10 of the cutting disk 9 that is not covered by the protective hood 11.

In the first end position 37, illustrated in FIG. 1, of the protective hood 11, the line 47 encloses a relatively small opening angle β with the longitudinal center axis 13. In particular, the opening angle β is less than 20°, in particular less than 10°. In the side view illustrated in FIG. 1, as seen parallel to the rotational axis 17, the handles 5 and 12 are located above the longitudinal center axis 13. The portion of the circumference 10 of the cutting disk 9 that is not covered by the protective hood 11 and is located on the same side of the longitudinal center axis 13 as the handles 5 and 12 is relatively small and extends through the opening angle β. In the illustration in FIG. 1, the portion of the circumference 10 that is located above the longitudinal center axis 13 is located on the same side of the longitudinal center axis 13 as the handles 5 and 12.

The work apparatus 1 has a control unit 20. The control unit 20 controls the drive motor 3.

To determine the position of the protective hood 11, the work apparatus 1 has a detection device 19 (FIG. 4). The detection device 19 includes a magnet 27 and a sensor module 26, which will be explained in more detail in the following text.

In FIG. 2, the cantilever arm 8 is illustrated without its cover 30. The cantilever arm 8 has a base body 25. The cover 30 can be formed in a multipart manner. A multipart configuration of the base body 25 can also be provided.

In the embodiment, the cutting disk 9 is driven by the drive motor 3 via a belt drive 49. The belt drive 49 includes a drive belt 18, which is wrapped around a first pulley 14, driven by the drive motor 3, and a second pulley 16, connected to the cutting disk 9. The first pulley 14 is mounted rotatably about an axis 15. The axis 15 may, in particular, coincide with the axis of the output shaft of the drive motor 3. The belt drive 49 may also be a multistage belt drive 49.

The longitudinal center axis 13 of the cantilever arm 8 extends in particular through the axis 15 and the rotational axis 17. In particular, the longitudinal center axis 13 extends perpendicularly to the axis 15 and perpendicularly to the rotational axis 17.

FIG. 2 shows the protective hood 11 in a position in which a relatively large portion of the circumference 10 of the cutting disk 9, which portion extends above the longitudinal center axis 13 in the illustration, is not covered by the protective hood 11. The line 47 encloses, with the longitudinal center axis 13, an opening angle β which is much greater than the opening angle β in the first end position 37, illustrated in FIG. 1, of the protective hood 11. In the illustration in FIG. 2, the opening angle β is approximately 90°. The protective hood 11 is in a second end position 38. In the second end position 38, the protective hood 11 is open to a maximum.

As FIG. 2 shows, in the second end position 38 of the protective hood 11, the magnet 27 is not located between the cantilever arm 8 and cutting disk 9 but outside the region covered by the cantilever arm 8. The sensor module 26 is arranged on the cantilever arm 8 between a belt tensioning device 40 and the second pulley 16. The magnet 27 extends through an extension angle α, which is, in particular, at least 35° about the rotational axis 17.

In order to pivot the protective hood 11 from the position illustrated in FIG. 1 into the position illustrated in FIG. 2, the operator has to move the protective hood 11 in an opening direction 31. The opening direction 31 extends counter to the direction of rotation 50 of the cutting disk 9 during operation.

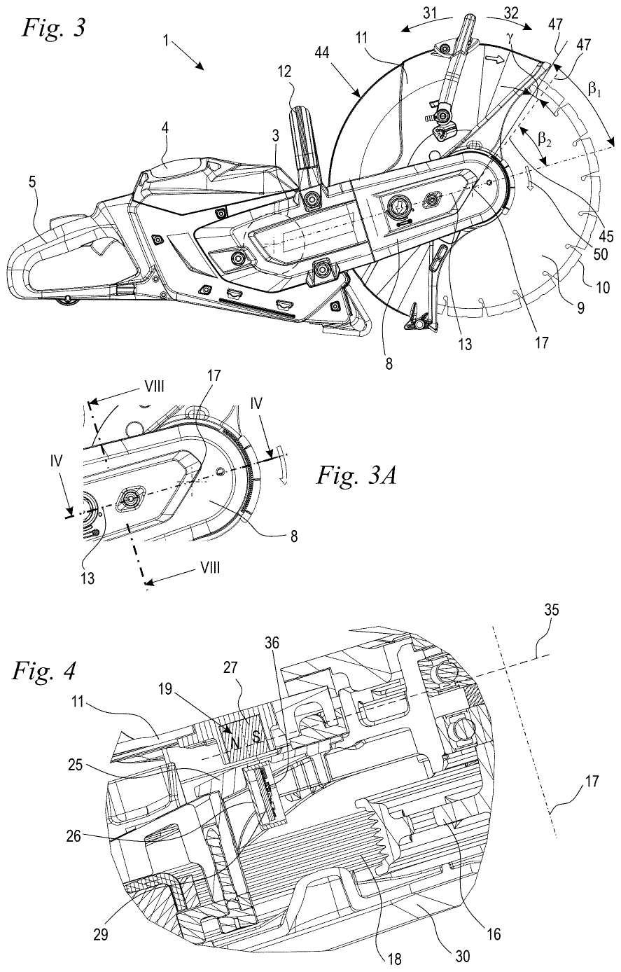

As FIG. 3 shows, the protective hood 11 can be adjusted in an opposite closing direction 32 by the operator in order to reduce the opening angle β. The closing direction 32 extends in the direction of the direction of rotation 50 of the cutting disk 9.

FIG. 3 shows the protective hood 11 in a first position 44. In the first position 44, the line 47 encloses, with the longitudinal center axis 13, a first opening angle β₁. In the first position 44, the portion of the circumference 10 of the cutting disk 9 that is located on the same side of the longitudinal center axis 13 as the handles 5 and 12 and is not covered radially toward the outside in relation to the rotational axis 17 by the protective hood 11 is as large as the first opening angle β₁.

A second position 45 of the protective hood 11, in which the protective hood 11 has been adjusted somewhat further in the closing direction 32, is schematically indicated by a dashed line in FIG. 3. In the second position 45, the line 47 encloses a second opening angle β₂ with the longitudinal center axis 13. In the second position 45, the portion of the circumference 10 of the cutting disk 9 that is located on the same side of the longitudinal center axis 13 as the handles 5 and 12 and is not covered radially toward the outside in relation to the rotational axis 17 by the protective hood 11 is as large as the second opening angle β₂.

In order to adjust the protective hood 11 between the positions 44 and 45, the protective hood 11 has to be adjusted through an angle γ. The angle γ is, in particular, at least 1°, in particular at least 2°.

When the protective hood 11 is adjusted in the opening position 31 from the first end position 37 into the second end position 38, first of all the second position 45 is reached and then the first position 44. When the protective hood 11 is adjusted in the closing direction 32 from the second end position 38 into the first end position 37, first of all the first position 44 is reached and then the second position 45.

FIG. 4 shows a section through the cantilever arm 8 and protective hood 11 in the region of the detection device 19. The detection device 19 includes the magnet 27, which is secured in a recess in the protective hood 11. The magnet 27 may have been molded in place, adhesively bonded or secured to the protective hood by clamping. Other possible ways of securing may also be provided. In FIG. 4, the north pole N and south pole S of the magnet 27 are schematically indicated. As FIG. 4 shows, an imaginary plane 35, which is parallel to the cutting disk 9 and perpendicular to the rotational axis 17 of the cutting disk 9, intersects the north pole N and south pole S of the magnet 27. The plane 35 intersects the end sides of the magnet 27, at which the field lines emerge from the magnet 27.

The sensor module 26 includes a circuit board 29, on which a Hall sensor 36 is arranged as the sensor. The Hall sensor 36 detects changes in the magnetic field. For a compact and space-saving arrangement, the sensor module 26 is arranged such that the circuit board 29 is parallel to the rotational axis 17 and perpendicular to the plane 35. It has been found that, even with this arrangement of the sensor module 26 and magnet 27, sufficiently good signals are generated for detecting the position of the protective hood 11.

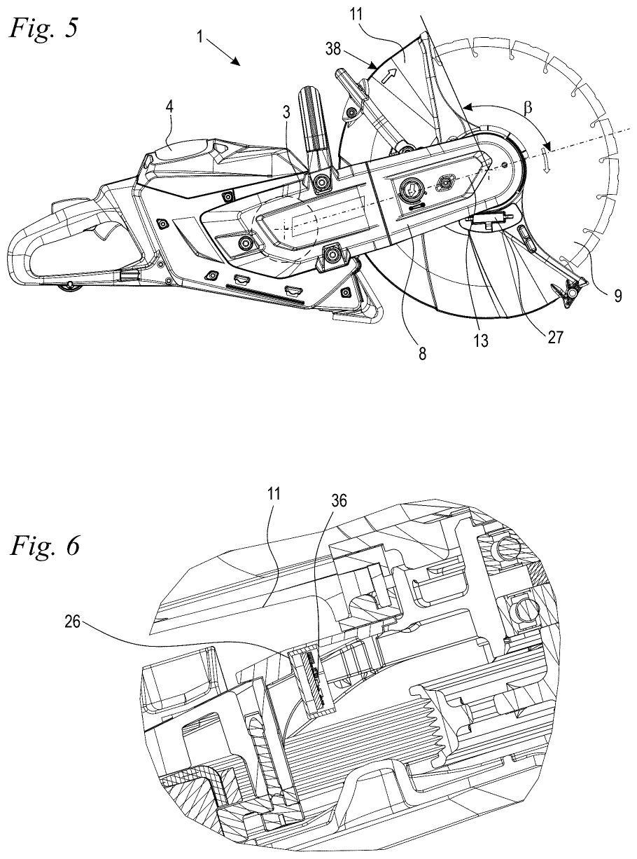

FIG. 5 shows the work apparatus 1 with the protective hood 11 in a position in which the protective hood 11 is completely open. The position, illustrated in FIG. 5, of the protective hood 11 is the second end position 38. As FIG. 5 shows, the magnet 27 is located entirely outside the region covered by the cantilever arm 8. The magnet 27 is not located in a region in which the magnetic field of the magnet 27 is still able to be detected by the Hall sensor 36 of the sensor module 26.

In FIG. 6, which shows a section through the cantilever arm 8 in the second end position 38, illustrated in FIG. 5, of the protective hood 11, it is apparent that no magnet 27 is arranged in the region of the sensor module 26. As a result, in the first position 44, illustrated in FIGS. 3 and 4, and in the second end position 38, illustrated in FIGS. 5 and 6, of the protective hood 11, the sensor module 26 delivers different measured values.

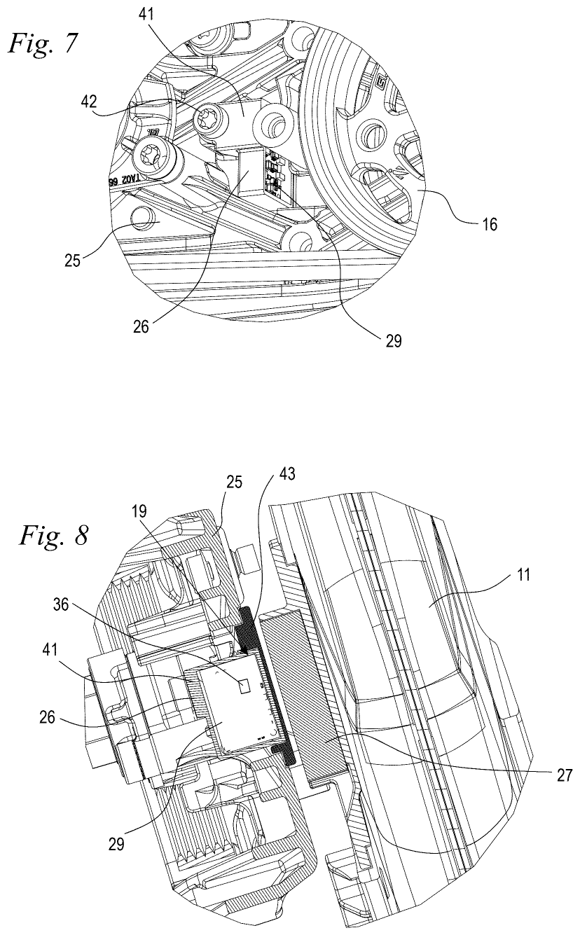

The arrangement and configuration of the sensor module 26 are also illustrated in FIGS. 7 and 8. The sensor module 26 includes a housing part 41, in which the circuit board 29 is held, for example molded in place. The housing part 41 may, for example, be secured to the base body 25 of the cantilever arm 8 via a screw 42. In the region of the sensor module 26, the base body 25 has, on the side facing the protective hood 11, a covering 43 made of nonmetallic material, in order to reduce the influence of the metallic cantilever arm 8 on the magnetic flux of the magnet 27.

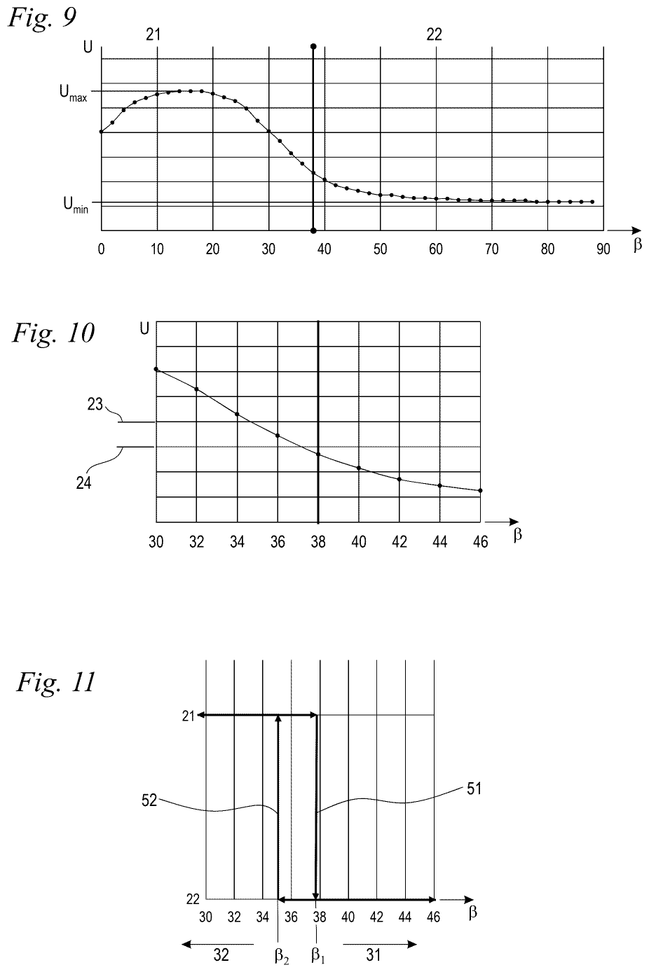

FIGS. 9 and 10 show the course of the measured value U, in the embodiment the voltage, that the detection device 19 delivers depending on the opening angle β. As FIG. 9 shows, the measured value U decreases significantly between an opening angle β of about 20° and an opening angle β of about 50° as the opening angle β increases, that is, when the protective hood 11 is adjusted in the opening direction 11. In the range between an opening angle β of about 10° to 20°, a maximum measured value Uₘₐₓ is reached. Starting from an opening angle β of about 60°, the measured value U remains largely constant at a minimum measured value Uₘᵢₙ.

In the region of the maximum measured value Uₘₐₓ, the magnet 27 is located entirely in the region of the Hall sensor 36. This corresponds to the relative position, illustrated in FIGS. 4 and 8, of the sensor module 26 and magnet 27.

Starting from an opening angle β of about 50° to 60°, the magnet 27 is located entirely outside the region that can be detected by the Hall sensor 36. This corresponds to the relative position, illustrated in FIGS. 5 and 6, of the sensor module 26 and magnet 27.

For the switch from the first operating mode 21 into the second operating mode 22, a first threshold value 23 is provided, which is indicated schematically in FIG. 10. For the switch from the second operating mode 22 into the first operating mode 21, a second threshold value 24 of the measured value U is provided, which is likewise indicated schematically in FIG. 10. The first threshold value 23 is assigned approximately to the first position 44. The second threshold value 24 is assigned approximately to the second position 45. Depending on the degree of soiling, the exact positions 44, 45 of the protective hood 11 that are assigned to the threshold values 23 and 24 can change over the lifetime of the work apparatus 1. The threshold values 23 and 24 have been chosen in particular such that, regardless of wear, the degree of soiling, vibrations and the like, a spacing of at least 1°is maintained between the positions 44 and 45.

The difference between the threshold values 23 and 24 corresponds in particular to at least 5%, in particular at least 10%, of the difference between the minimum measured value Uₘᵢₙ and maximum measured value Uₘₐₓ.

The position, detected by the detection device 19, of the protective hood 11 is used, as illustrated schematically in FIG. 11, to switch between two operating modes 21 and 22. In the first operating mode 21, the magnet 27 is located in the region of the sensor module 26. This corresponds to the position, illustrated in FIGS. 4 and 8, of the magnet 27 and sensor module 26. In the first operating mode 21, the opening angle β is smaller than the first opening angle β₁. When the protective hood 11 is moved in the opening direction 31 and reaches the first position 44, that is, the first opening angle β₁, the control unit 20 switches from the first operating mode 21 into the second operating mode 22. This is illustrated by the arrow 51 in FIG. 11.

If the protective hood is moved in a closing direction 32 from a position located between the first position 44 and the second end position 38, the switch does not occur upon reaching the first position 44 but only when the first position 44 has been crossed and a second position 45 is reached. This is illustrated by the arrow 52 in FIG. 11. The second position 45 corresponds to a second opening angle β₂, which is smaller than the opening angle β₁. The difference between the first opening angle β₁ and the second opening angle β₂ is, in particular, at least 1°, in particular at least 2°.

The control unit 20 is configured to operate the work apparatus 1 in a first operating mode 21 and a second operating mode 22. The two operating modes 21 and 22 differ in terms of the actuation of at least one component of the work apparatus 1. For example, one component of the work apparatus 1 may be active in one of the operating modes 21 and 22 and not active in the other of the operating modes 22 and 21.

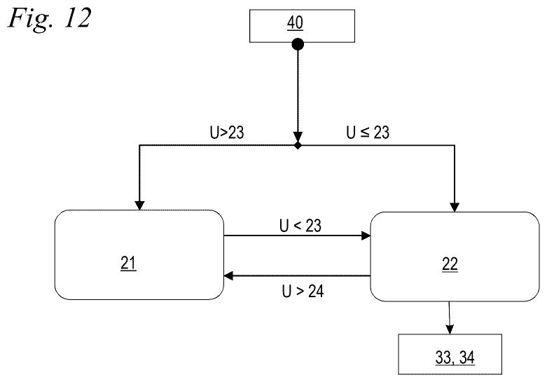

To switch between the operating modes 21 and 22, the control unit 20 (FIG. 1) compares the measured value U delivered by the detection device 19 with a first threshold value 23 and a second threshold value 24 (FIG. 12). As FIG. 9 shows, in the embodiment, a large opening angle β corresponds to a small measured value U and a small opening angle β corresponds to a large measured value U.

The switch between the operating modes 21 and 22 takes place when the protective hood 11 is moved in the opening direction 31 and the first position 44 is crossed or when the protective hood 11 is moved in the closing direction 32 and the second position 45 is crossed.

The first position 44 corresponds to the first opening angle β₁. The crossing of the first position 44 during a movement in the opening direction 31 corresponds to opening of the protective hood 11 beyond the first opening angle β₁. The second position 45 corresponds to the second opening angle β₂. The crossing of the second position 45 during a movement in the closing direction 32 corresponds to closing of the protective hood 11 beyond the second opening angle β₂.

FIG. 12 schematically shows a method for operating the work apparatus 1. The method step 46 corresponds to the starting of the work apparatus 1. First a check is made as to whether the measured value U is greater than the first threshold value 23. Alternatively, during start-up, the first operating mode 21 can be selected on the basis of the second threshold value 24 or on the basis of some other value.

If the measured value U lies above the first threshold value 23, the control unit 20 initially controls the work apparatus 1 according to the first operating mode 21. If the measured value U is less than or equal to the first threshold value 23, the control unit 20 initially controls the work apparatus 1 according to the second operating mode 22.

The measured value U is, in particular, monitored continuously.

If the measured value U drops below the first threshold value 23 because the operator is adjusting the protective hood 11 back in the closing direction 32 into the first position 44, there is initially no switch into the first operating mode 21. It is only when the second threshold value 24, which is assigned to the second position 45, is also reached that the control unit 20 switches back into the first operating mode 21.

In the second operating mode 22, provision is made, in particular, for a rotational speed limiting device 33 of the work apparatus 1 to be active and/or for a brake unit 34 of the work apparatus 1 to be active. The rotational speed limiting device 33 ensures that the rotational speed of the drive motor 3 cannot rise above a preset value. In particular, the maximum rotational speed of the work apparatus 1 in the second operating mode 22 is 60% to 70% of the maximum rotational speed of the work apparatus 1 in the first operating mode 21.

The brake unit 34 brakes the cutting disk 9. In particular, the cutting disk 9 is braked via braking of the drive motor 3, that is, via a motor brake. Alternatively, or when the drive motor 3 is an internal combustion engine, an additional mechanical brake unit or only a mechanical brake unit, for example a band brake, can be provided.

In the first operating mode 21, the rotational speed limiting device 33 and the brake unit 34 are, in particular, not active.

It is understood that the foregoing description is that of the preferred embodiments of the invention and that various changes and modifications may be made thereto without departing from the spirit and scope of the invention as defined in the appended claims.

1. A work apparatus comprising:
a drive motor;
a cutting disk configured to be driven by said drive motor and defining a disk circumference;
a protective hood which covers said cutting disk around a portion of said disk circumference and which is adjustable by a user in an opening direction and an opposite closing direction;
a detection device for detecting a position of said protective hood;
a control unit configured to operate the work apparatus in a first operating mode and in a second operating mode and, depending on the position of said protective hood detected by said detection device, to switch from said first operating mode into said second operating mode upon adjustment of said protective hood in the opening direction and to switch from said second operating mode into said first operating mode upon adjustment of said protective hood in the closing direction, wherein the switch from said first operating mode into said second operating mode occurs with said protective hood in a first position; and,
wherein the switch from said second operating mode into said first operating mode occurs with said protective hood in a second position, wherein said second position of said protective hood is reached upon adjustment of said protective hood in the closing direction after said first position.

2. The work apparatus of claim 1, wherein said first position and said second position are spaced apart from one another by an angle of at least 1° about a rotational axis of said cutting disk.

3. The work apparatus of claim 2, wherein said angle is at least 2°.

4. The work apparatus of claim 1, wherein said control unit is configured to activate a rotational speed limiting device in said second operating mode.

5. The work apparatus of claim 1, wherein said control unit is configured to activate a brake unit of the work apparatus in said second operating mode.

6. The work apparatus of claim 1, wherein said detection device has at least one magnet and at least one sensor for detecting a magnetic field strength of said at least one magnet.

7. The work apparatus of claim 6, wherein said at least one sensor includes a Hall sensor.

8. The work apparatus of claim 6, wherein the work apparatus is a cut-off saw further comprising a cantilever arm on which said cutting disk is rotatably mounted, wherein said at least one sensor is arranged on said cantilever arm; and, said at least one magnet is arranged on said protective hood.

9. The work apparatus of claim 6, wherein said at least one magnet has a north pole and a south pole; and, said at least one magnet is oriented such that an imaginary plane that extends perpendicularly to the rotational axis of said cutting disk intersects said at least one magnet through said north pole and said south pole.

10. The work apparatus of claim 6, wherein said at least one sensor is secured to a circuit board which is inclined at less than 45° to a rotational axis of the cutting disk.

11. The work apparatus of claim 10, wherein said circuit board extends parallel to the rotational axis of said cutting disk.

12. The work apparatus of claim 1, wherein the work apparatus is a cut-off saw further comprising:
at least one handle;
a cantilever arm on which said cutting disk is rotatably mounted;
said cantilever arm defining a longitudinal center axis which extends in a longitudinal direction of said cantilever arm and intersects a rotational axis of said cutting disk;
wherein, upon adjustment of said protective hood in the opening direction, a portion of said disk circumference that is not covered by said protective hood increases in size, said portion being arranged on a same side of the longitudinal center axis, as seen in a direction of the rotational axis of said cutting disk, as said at least one handle.

13. A method for operating a work apparatus having a drive motor, a cutting disk configured to be driven by the drive motor, a protective hood which covers the cutting disk around a portion of a circumference of the cutting disk and which is adjustable by the user in an opening direction and an opposite closing direction, the work apparatus further having a detection device for detecting a position of the protective hood and a control unit, wherein the control unit is configured to operate the work apparatus in a first operating mode and in a second operating mode and, depending on the position of the protective hood detected by the detection device, switches from the first operating mode into the second operating mode upon adjustment of the protective hood in the opening direction and switches from the second operating mode into the first operating mode upon adjustment of the protective hood in the closing direction, the method comprising:
switching. via the control unit, from the first operating mode into the second operating mode with the protective hood in a first position; and,
switching, via the control unit, from the second operating mode into the first operating mode with the protective hood in a second position, wherein the second position of the protective hood is reached upon adjustment in the closing direction after the first position.
